(19) United States
(12) Patent Application Publication
(10) Pub. No.: US 2022/0234240 A1
(43) Pub. Date: Jul. 28, 2022

(54) TOOL DEVICE AND METHOD

(71) Applicant: Festool GmbH, Wendlingen (DE)

(72) Inventors: Julian Schneck, Wolfschlugen (DE); Christian Schock, Schorndorf (DE); Markus Schmid, Uhingen (DE)

(21) Appl. No.: 17/617,761

(22) PCT Filed: Apr. 27, 2020
(86) PCT No.: PCT/EP2020/061609

§ 371 Date: Dec. 9, 2021

(30) Foreign Application Priority Data
Jun. 11, 2019 (DE) 10 2019 208 438.9

(51) Int. Cl. B27B 5/38

(52) U.S. Cl. CPC B27B 5/38

(57) ABSTRACT

The invention relates to a tool device (10), comprising a shaft (2) and a braking device (12) with at least one brake body (3), in particular in the form of a brake disc, and a brake section (14), wherein the tool device (10) is adapted to, in the course of a braking operation, put the braking device (12) from a release state via a feed state into a braking state, provide, in the release state, a rotationally fixed coupling between the at least one brake body (3) and the shaft (2), so that the at least one brake body (3) rotates with the shaft (2) in the release state, provide, in the feed state, a relative rotational movement between the at least one brake body (3) and the shaft (2) and convert the relative rotational movement into an axial movement (31) of the at least one brake body (3) towards the brake section (14), and exert, in the braking state, a braking force on the shaft (2) by a contact of the at least one brake body (3) with the brake section (14), so that the shaft (2) is braked.

The invention relates to a tool device comprising a shaft. Preferably, the tool device comprises a drivable tool coupled to the shaft. Expediently, the tool is drivable via the shaft.

EP 1 234 285 B1 describes a table saw having a braking mechanism comprising at least one pawl which is brought into engagement with the saw blade to stop the rotating saw blade.

It is an objection of the invention to provide a tool device that can be operated with less effort.

The object is solved by a tool device according to claim 1. The tool device comprises a braking device with at least one brake body, in particular designed as a brake disc, and a brake section. The tool device is adapted to set, within a braking operation, the braking device from a release state via a feed state into a braking state. In the release state, the at least one brake body is coupled to the shaft in a rotationally fixed manner, so that the at least one brake body rotates with the shaft in the release state. In the feed state, a relative rotational movement is provided between the at least one brake body and the shaft and the relative rotational movement is converted into an axial movement of the brake body towards the brake section. In the braking state, the at least one brake body is in contact with the brake section and exerts a braking force on the shaft so that the shaft is braked. Expediently, braking the shaft brakes the tool.

The term braking in this context refers to the reduction of a speed, in particular a rotational speed. Braking is expediently carried out to a standstill or not to a standstill.

In EP 1 234 285 B1 mentioned at the beginning, a pawl is brought into engagement with the saw blade in order to stop the saw blade. This usually results in damage to the saw blade and the pawl, so that both have to be replaced so that the table saw can continue to be operated.

In contrast, in the tool device described, the tool and/or the at least one brake body expediently remain undamaged and/or continue to be usable even after the tool has been braked, so that no replacement is required for further operation.

For this reason, the described tool device can be operated with less effort.

Advantageous further embodiments are the subject of the subclaims.

The invention further relates to a method for braking a shaft of a tool device, comprising the step of: putting a braking device, which comprises at least one brake body, in particular designed as a brake disc, and a brake section, from a release state, in which the at least one brake body is coupled to the shaft in a rotationally fixed manner, so that the at least one brake body rotates with the shaft, via a feed state, in which the at least one brake body performs an axial movement towards the brake section caused by a relative rotational movement between the at least one brake body and the shaft, to a braking state in which the at least one brake body is in contact with the brake section and exerts a braking force on the shaft so that the shaft is braked.

In a preferred embodiment, the method is carried out using a tool device described herein.

Further exemplary details as well as exemplary embodiments are explained below with reference to the figures. Thereby shows

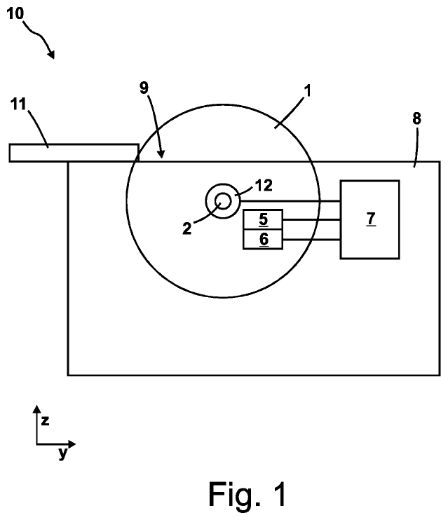

FIG. 1 a schematic representation of a tool device,

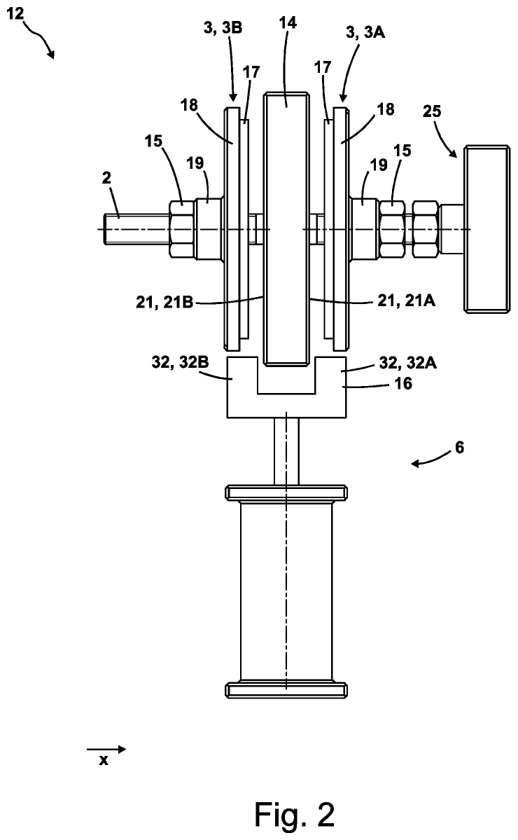

FIG. 2 a braking device in a release state,

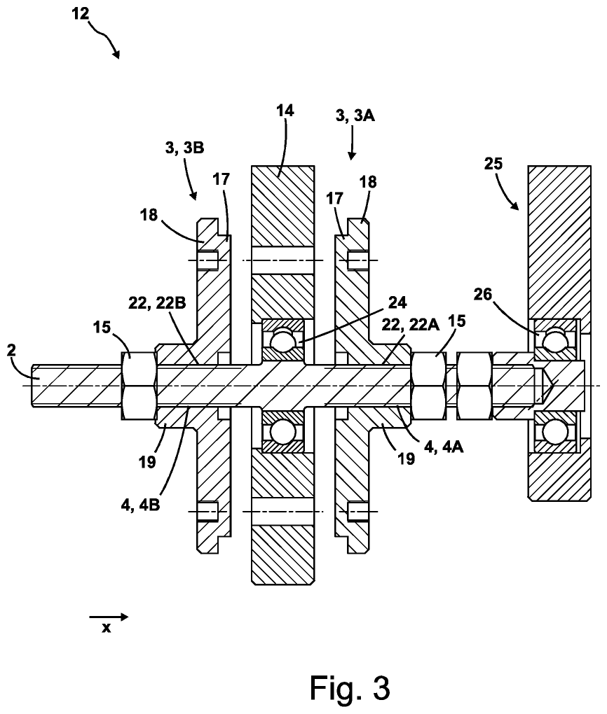

FIG. 3 a sectional view of the braking device,

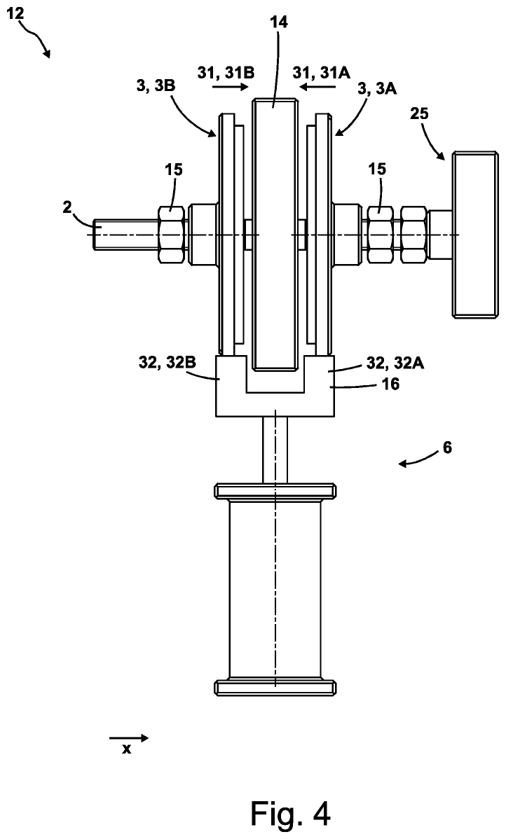

FIG. 4 the braking device in a feed state,

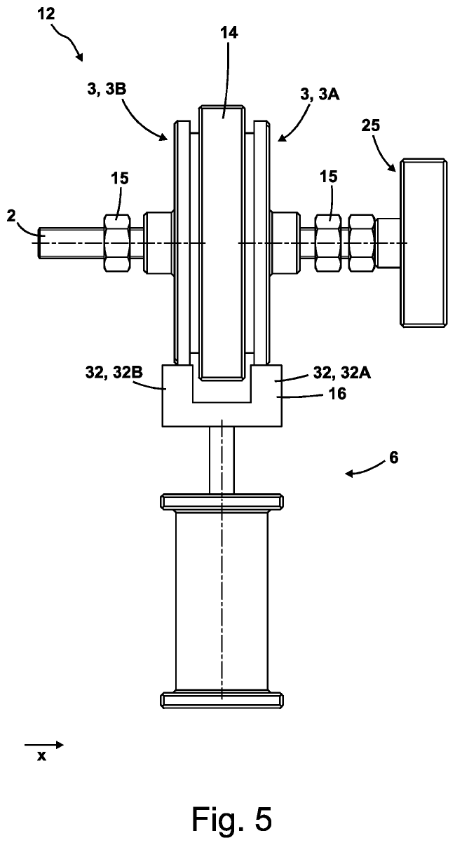

FIG. 5 the braking device in a braking state,

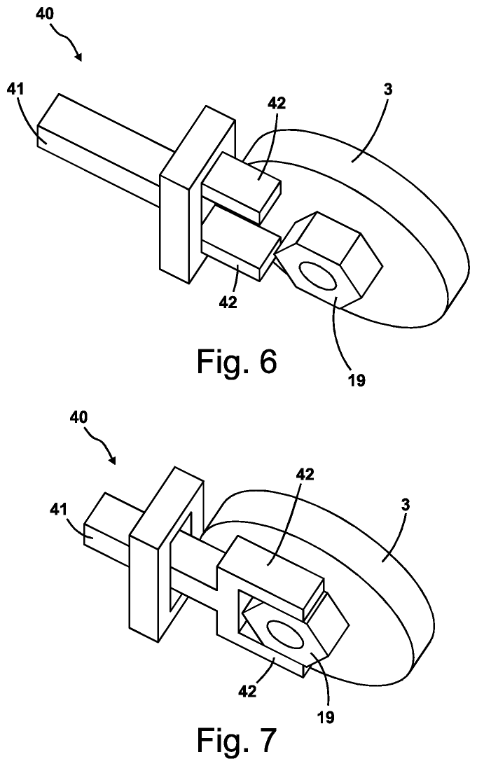

FIG. 6 a reset mechanism in an inactive position, and

FIG. 7 the reset mechanism in an active position.

In the following explanation, reference is made to the directions “x”, “y” and “z” shown in the figures. The x-direction, y-direction and z-direction are orthogonal to each other. The x-direction and y-direction may also be referred to as horizontal direction, and the z-direction may be referred to as vertical direction. The directions “radial direction” and “axial direction” mentioned below are to be understood in particular with respect to the longitudinal axis of the shaft 2. In an exemplary embodiment, the longitudinal axis or axial direction of the shaft 2 is parallel to the x-direction. The term “axial movement” means in particular a movement parallel to the longitudinal axis of the shaft 2.

FIG. 1 shows a tool device 10 with a drivable tool 1. The tool device 10 comprises a shaft 2 coupled to the tool 1, by means of which shaft 2 the tool 1 is expediently drivable.

The tool device 10 comprises a braking device 12, which is exemplarily shown in FIGS. 2 to 5. The braking device 12 comprises at least one brake body 3. The at least one brake body 3 is expediently configured as a brake disc. Exemplarily, the braking device 12 comprises two brake bodies 3—a first brake body 3A and a second brake body 3B. Alternatively, the braking device 12 may comprise only one brake body 3.

The tool device 10 further comprises a brake section 14. Exemplarily, the brake section 14 is located in the axial direction of the shaft 2 between the two brake bodies 3A, 3B. Preferably, the shaft 2 is rotatably mounted on the brake section 14.

The tool device 10 is configured to put, as part of a braking operation, the braking device 12 from a release state to a braking state via a feed state.

The release state is exemplarily shown in FIGS. 2 and 3. In the release state, the at least one brake body 3 is coupled to the shaft 2 in a rotationally fixed manner, so that the at least one brake body 3 rotates with the shaft 2 (about the longitudinal axis of the shaft) in the release state. In particular, the rotationally fixed coupling is such that the at least one brake body 3, preferably both brake bodies 3A, 3B, co-rotates with the shaft 2 (at the same rotational speed) in a state in which the shaft 2 rotates, and in a state in which the shaft does not rotate, the brake body 3, preferably both brake bodies 3A, 3B, also does not rotate. Exemplarily, both brake bodies 3A, 3B are non-rotatably coupled to the shaft 2 and rotate with the shaft 2 when the shaft 2 rotates. In an exemplary embodiment, the tool device 10 comprises a coupling mechanism for providing the rotationally fixed coupling in the release mode. In an exemplary embodiment, the coupling mechanism is configured to provide the rotationally fixed coupling by frictional engagement. In an exemplary embodiment, the coupling mechanism comprises at least one coupling section 15, exemplarily a nut, which is non-rotatably fixed to the shaft 2 and is pressed against the at least one brake body 3 in the release mode, so as to provide a frictional connection between the coupling section 15 and the at least one brake body 3, so as to provide the non-rotatable coupling between the at least one brake body 3 and the shaft 2.

In the release state, the shaft 2 can expediently rotate freely and is in particular not braked by the braking device 12. For example, the braking device 12 assumes the release state during normal operation—that is, in particular during rotation of the shaft 2 and the tool 1 and, for example, during processing of the workpiece 11 with the tool 1.

The tool device 10 is configured to move the braking device 12 from the release state to the feed state.

FIG. 4 shows the braking device 12 in the feed state. In the feed state, a relative rotational movement is provided between the at least one brake body 3, preferably both brake bodies 3A, 3B, and the shaft 2. Preferably, the shaft 2 has a higher rotational speed than the brake body 3 during the relative rotational movement. In particular, the relative rotational movement is provided by rotationally braking the at least one brake body 3, preferably both brake bodies 3A, 3B, relative to the shaft 2. This is exemplarily done by bringing an actuating section 16 into contact with the at least one brake body 3. By braking the at least one brake body 3, the rotational coupling between the at least one brake body 3 and the shaft 2 is released, so that the at least one brake body 3 is no longer rotationally coupled to the shaft 2 and rotates relative to the shaft 2. Expediently, the shaft 2 rotates faster than the at least one brake body 3 in the feed state, in particular faster than both brake bodies 3A, 3B.

Alternatively, or in addition to the embodiment described above in which the tool device 10 brakes the brake body 3 to provide the relative rotational movement, the tool device 10 may also be configured to provide the relative rotational movement by a jerky change in rotational speed of the shaft 2, in particular a rotational acceleration of the shaft 2.

The relative rotational movement between the at least one brake body 3, preferably the two brake bodies 3A, 3B, and the shaft 2 is converted into an axial movement 31 of the at least one brake body 3, preferably the two brake bodies 3A, 3B, towards the brake section 14. Suitably, the at least one brake body 3 performs the axial movement until the at least one brake body 3 is in contact with the brake section 14. The axial movement 31 is parallel to the x-direction. Preferably, the axial movement 31 is a linear movement.

Exemplarily, the axial movement 31 is provided by a thread 4 arranged in particular on the shaft 2, with which thread 4 the at least one brake body 3 is in engagement. Via the thread 4, the relative rotational movement between the at least one brake body 3 and the shaft 2 is thus expediently converted into a relative axial movement between the at least one brake body 3 and the shaft 2.

FIG. 5 shows the braking device 12 in the braking state. In the braking state, the at least one brake body 3, preferably both brake bodies 3A, 3B, has reached the brake section 14. The at least one brake body 3 is in contact with the brake section 14 and exerts a braking force on the shaft 2, so that the shaft 2 and thereby also the tool 1 are braked.

The contact between the at least one brake body 3 and the brake section 14 prevents a (further) relative rotational movement between the at least one brake body 3 and the brake section 14, in particular by frictional engagement between the at least one brake body 3 and the brake section 14. Furthermore, the contact between the at least one brake body 3 and the brake section 14 prevents a further axial movement of the at least one brake body 3 towards the brake section 14, in particular by positive engagement between the at least one brake body 3 and the brake section 14.

Due to the motion coupling between the at least one brake body 3 and the shaft 2—namely the coupling, provided for example by the thread 4, between relative rotational movement and relative axial movement between the at least one brake body 3 and the shaft 2—the shaft 2 can only continue to rotate relative to the brake body 3 if the axial movement of the brake body 3 continues. Consequently, by preventing the axial movement of the brake body 3, the relative rotational movement between the brake body 3 and the shaft 2 is prevented. Thereby, due to the aforementioned stopping of the relative rotational movement between the brake body 3 and the brake section 14, the rotational movement of the shaft 2 is also stopped relative to the brake section 14. The brake section 14 is expediently a stationary part of the tool device 10, and consequently the shaft 2 and expediently also the tool 1 are stopped relative to a stationary part of the tool device 10.

In particular, the braking device 12 is self-locking and/or self-amplifying. As soon as a brake body 3A, 3B contacts the brake section 14, each further rotation of the shaft 2 increases the braking effect on the shaft 2. In particular, the brake bodies 3A, 3B are pressed more strongly against the brake section 14 by each further rotation of the shaft 2, so that in particular the frictional connection between the brake bodies 3A, 3B and the shaft 2 and thus the braking effect is increased.

Suitably, the axial forces exerted by the first brake body 3A and the second brake body 3B on the shaft 2 in the braking state cancel each other out. Preferably, the first brake body 3A and the second brake body 3B simultaneously strike the brake section 14 after performing the axial movement.

Further exemplary details are explained below.

First of all, to tool device 10:

In an exemplary embodiment, the tool device 10 is a saw. Suitably, the tool 1 is a rotating saw blade. Preferably, the tool device 10 is a circular table saw. Alternatively, the tool device 10 may be a different tool device. In particular, the tool device 10 may be formed as a stationary or semi-stationary machine. Furthermore, the tool device 10 may be configured as a hand-guided machine, in particular a hand-guided machine tool. Preferably, the tool device 10 is designed as a chop saw, plunge saw, pendulum hood saw, band saw, jigsaw, router and/or angle grinder. In particular, the tool device 10 is a power tool.

In an exemplary embodiment, the tool device 10 comprises the tool 1, the shaft 2, a drive unit 5, an actuator unit 6, and a control unit 7. Further, the tool device 10 expediently comprises a support structure 8 and/or a support surface 9.

The support structure 8 is exemplarily designed as a housing. The drive unit 5, the actuator unit 6 and/or the control unit 7 are expediently accommodated in the support structure 8.

Exemplarily, the support surface 9 is arranged on the upper side of the support structure 8. The support surface 9 serves to support a workpiece 11 while the workpiece 11 is being processed by the tool 1. Exemplarily, the support surface 9 represents an x-y plane. Exemplarily, the tool 1 protrudes from the support surface 9, in particular in the z-direction.

The drive unit 5 is exemplarily designed as a rotary drive, in particular as an electric rotary drive. The drive unit 5 serves to drive the tool 1, in particular to set the tool 1 in rotation, preferably in clockwise direction. The tool 1 is coupled to the drive unit 5 via the shaft 2. The drive unit 5 is designed to drive the shaft 2, in particular to set it in rotation, via which in turn the tool 1 is driven. Exemplarily, the tool 1 is connected to the shaft 2 in a rotationally fixed manner, so that the tool 1 rotates with the rotating shaft 2.

In particular, the shaft 2 is a shaft of the drive train of the tool device 10. The shaft 2 and the tool 1 are expediently rotatably mounted with respect to the support structure 8.

The shaft 2 is aligned with its longitudinal axis parallel to the x-direction. Exemplarily, the shaft 2 has a circular-cylindrical basic shape. The axis of rotation of the tool 1 is expediently aligned parallel to the x-direction. Exemplarily, the shaft 2 and the tool 1 are aligned coaxially to each other.

Expediently, the actuator unit 6 serves to move the braking device 12 from the release state to the feed state, as will be further explained below.

The control unit 7 is expediently adapted to provide a drive unit control signal to the drive unit 5 to cause the drive unit 5 to drive the tool 1. The control unit 7 is suitably further adapted to provide an actuator unit control signal to the actuator unit 6 to cause the actuator unit 6 to set the braking device 12 to the feed state. The control unit 7 is suitably further adapted to detect an operating state and to initiate the braking operation based on the detected operating state, in particular by providing the actuator unit control signal to the actuator unit 6 and/or a control signal to the drive unit 5. The operating state is in particular an emergency state. The emergency state is in particular a potentially dangerous situation for a user, in which the user may be injured by the tool and/or the workpiece, for example. The control unit 7 is suitably configured to detect the emergency state on the basis of a detected contact between the tool 1 and the human body, for example a finger.

Preferably, the tool device 10, in particular the control unit 7, is configured to supply an electrical detection signal to the tool 1 and to detect the emergency state on the basis of a change in the detection signal. More expediently, the tool device 10, in particular the control unit 7, is configured to supply the electrical detection signal to the tool 1 by capacitive coupling. More expediently, the tool device 10, in particular the control unit 7, is adapted to detect the emergency state, in particular the contact between the tool 1 and the human body, on the basis of a capacitive change. Further details on how the detection of the emergency state can be implemented in an exemplary manner are described in EP 1 234 285 B1.

The control unit 7 is suitably further adapted to detect a kickback as the emergency state. The term “kickback” means in particular a state in which, during processing of the workpiece 11 by the tool device 10, a sudden and unexpected force occurs between the tool device 10 and the workpiece 11, causing the tool device 10 and/or the workpiece 11 to move.

The tool device 10 expediently comprises a sensor device, for example an acceleration sensor and/or a force sensor, in particular a strain gauge arrangement, for detecting the kickback. Such a sensor device is described, for example, in WO 2019/020307 A1.

The tool device 10 is expediently configured to bring the tool 1 to a standstill within 5 ms or less by performing the braking operation, expediently from a driven, in particular rotating, state of the tool 1 in which processing of the workpiece 11 is or can be performed.

With reference to FIGS. 2 to 5, the braking device 12 will be discussed in more detail below.

Expediently, the braking device 12 is integrated in the tool device 10. The braking device 12 is in particular an actively switched brake (preferably via the control unit 7 and/or the actuator unit 6). The braking device 12 is in particular reversible, so that it can be moved from the braking state back to the release state (and from there, expediently, back to the braking state), preferably without having to replace a component of the braking device 12 for this purpose.

In an exemplary embodiment, the braking device 12 comprises the shaft 2, the brake bodies 3, the brake section 14, the coupling sections 15 and the actuating section 16. The shaft 2 is oriented with its longitudinal axis parallel to the x-direction. The shaft 2 extends through the brake bodies 3, the coupling sections 15 and expediently also through the brake section 14. The brake bodies 3 are arranged distributed in the x-direction. In particular, the brake bodies 3 are aligned coaxially with the shaft 2 and coaxially with each other. The brake section 14 is arranged in the x-direction between the brake bodies 3. The brake section 14 and the brake bodies 3 are arranged together in the x-direction between the coupling sections 15. The brake section 14, the brake bodies 3 and the coupling sections 15 do not overlap each other in the x-direction. In particular, the actuating section 16 is arranged spaced apart from the shaft 2 in the radial direction.

In the release state (see FIGS. 2 and 3), the shaft 2, the coupling sections 15 and the brake bodies 3 are coupled to each other in a rotationally fixed manner. For example, the brake bodies 3 are frictionally and/or positively coupled to the shaft 2 in the release state. The shaft 2 is freely rotatable relative to the brake section 14 in the release state. The brake bodies 3 are not in contact with the brake section 14 in the release state. The actuating section 16 is not in contact with the brake bodies 3 in the release state.

In the feed state (see FIG. 4), the shaft 2 and the brake bodies 3 are not coupled to each other in a rotationally fixed manner. The shaft 2 can rotate relative to the brake bodies 3. Expediently, the shaft 2 and the one brake body 3, in particular both brake bodies 3A, 3B, rotate in the same direction of rotation in the feed state. The shaft 2 continues to be freely rotatable relative to the brake section 14 in the feed state. The brake bodies 3 are not in contact with the brake section 14 in the feed state. The actuating section 16 is expediently in contact with the brake bodies 3 in the feed state.

In the braking state (see FIG. 5), the brake bodies 3 and the shaft 2 are coupled to the brake section 14 in a rotationally fixed manner. Furthermore, in the braking state, the brake bodies 3 are in contact with the brake section 14.

In the following, the brake bodies 3 will be discussed in more detail.

Exemplarily, two brake bodies 3 are present—a first brake body 3A and a second brake body 3B. According to an alternative embodiment, only one brake body 3 is present; that is, the first brake body 3A or the second brake body 3B is not present in the alternative embodiment.

The two brake bodies 3A, 3B are expediently formed in correspondence with each other. Explanations referring to a brake body 3 apply in particular to both brake bodies 3A, 3B. Furthermore, explanations relating to the first brake body 3A expediently apply in correspondence also to the second brake body 3B.

The brake bodies 3A, 3B are exemplary brake discs. The first brake body 3A may also be referred to as the first brake disc and the second brake body 3B may be referred to as the second brake disc.

The brake bodies 3 are expediently separate parts from each other. In particular, the two brake bodies 3A, 3B run separately from each other on the shaft 2.

Each brake body 3A, 3B comprises, in an exemplary manner, a respective disc section 18 which is aligned coaxially with the shaft 2. At the end face of each disc section 18 facing the brake section 14, there is exemplarily a respective contact region 17, in particular a flat contact region, for example a brake lining. The end face facing the brake section 14 is oriented perpendicular to the x-direction. In the braking state, the respective contact region 17 of each brake body 3A, 3B is in contact with the brake section 14. The contact regions 17 of the two brake bodies 3A, 3B are exemplarily aligned facing each other.

In an exemplary embodiment, each brake body 3A, 3B further comprises a respective cylinder section 19 which is coaxially aligned with the shaft 2. Each cylinder section 19 is arranged at the end face of the respective disc section 18 facing away from the brake section 14.

Each brake body 3A, 3B is in contact with a respective coupling section 15 with its end face facing away from the brake section 14, in particular with the end face of the respective cylinder section 19 facing away from the brake section 14. This expediently provides the rotationally fixed coupling to the shaft 2, in particular by frictional engagement.

Each brake body 3A, 3B expediently comprises a respective brake body thread 22A, 22B. Each brake body 3A, 3B is in engagement with the shaft 2 via its respective brake body thread 22A, 22B. The brake body threads 22A, 22B are expediently designed as internal threads. Each brake body thread 22A, 22B is expediently arranged in a through hole arranged centrally in the respective brake body 3A, 3B, in particular centrally in the respective disc section 18 and/or cylinder section 19.

In the following, the shaft 2 will be discussed in more detail:

The shaft 2 is exemplarily designed as a drive spindle. Preferably, the shaft 2 is designed as a threaded shaft. The shaft 2 is expediently connected to a motor shaft and/or the tool 1 in a torque-resistant manner.

In an exemplary embodiment, the shaft 2 comprises the first thread 4A. The first thread 4A is in engagement with the first brake body 3A, in particular with the first brake body thread 22A.

Expediently, the shaft 2 further comprises a second thread 4B. The second thread 4B is offset in the x-direction from the first thread 4A. The second thread 4B is in engagement with the second brake body 3B, in particular with the second brake body thread 22B.

The first thread 4A differs in its thread direction from the second thread 4B. Preferably, the thread direction of the first thread 4A is opposite to the thread direction of the second thread 4B. Expediently, the first thread 4A is a right-hand thread and the second thread 4B is a left-hand thread. Alternatively, the first thread 4A is a left-hand thread and the second thread 4B is a right-hand thread.

In the embodiment shown, the braking device 12 comprises the two threads 4A, 4B. According to an alternative embodiment, in particular an embodiment with only one brake body 3, the braking device comprises only one thread 4A or 4B.

The tool device 10 is adapted to convert the relative rotational movement 30 between each brake body 3A, 3B and the shaft 2 into the axial movement 31A, 31B of each brake body 3A, 3B towards the brake section 14. In particular, the tool device 10 is adapted, in the feed state, to set the two brake bodies 3A, 3B in opposite axial movements 31A, 31B towards the brake section 14 by the relative rotational movement 30 between the two brake bodies 3A, 3B and the shaft 2. Expediently, the brake bodies 3A, 3B move towards each other when performing the axial movements 31A, 31B.

To convert the relative rotational movement 30 into the axial movements 31A, 31B, the tool device 10 comprises a conversion mechanism, which is formed by the threads 4A, 4B and the brake body threads 22A, 22B, for example. The engagement of the first thread 4A with the first brake body thread 22A causes the first brake body 3A to undergo the first axial movement 31A towards the brake section 14 upon a relative rotational movement between the first brake body 3A and the shaft 2. In an exemplary embodiment, the first axial movement 31A is antiparallel to the x-direction. The engagement of the second thread 4B with the second brake body thread 22B causes the second brake body 3B to undergo a second axial movement 31B towards the brake section 14 upon a relative rotational movement between the second brake body 3B and the shaft 2. In an exemplary embodiment, the second axial movement 33B is parallel to the x-direction.

Next, the brake section 14 will be discussed.

Exemplarily, the brake section 14 is a part of the support structure 8 or is non-rotatably connected to the support structure 8, in particular to the support structure 8 configured as a housing. In particular, the brake section 14 is a stationary section. More expediently, the brake section 14 does not rotate with the shaft 2. The brake section 14 is configured to dissipate a force and/or a torque acting on the shaft 2 in the braking state.

In an exemplary embodiment, the brake section 14 has a basic plate-like shape. In particular, the brake section 14 is designed as a brake block and/or bearing block. In an exemplary embodiment, the largest side of the brake section 14 in terms of area is oriented normal to the x-direction. The brake section 14 has a first braking surface 21A, which faces the first brake body 3A and is in contact with the first brake body 3A in the braking state. The brake section 14 further comprises a second braking surface 21B facing the second brake body 3B and in contact with the second brake body 3B in the braking state. The first braking surface 21A and the second braking surface 21B are oriented in opposite directions.

Exemplarily, the brake section 14 comprises a through hole through which the shaft 2 is guided. Expediently, the brake section 14 comprises a pivot bearing 24, in particular a rolling bearing, which mounts the shaft 2.

The coupling sections 15 will be discussed in more detail below.

The coupling sections 15 serve to provide the rotationally fixed coupling between the brake bodies 3A, 3B and the shaft 2 in the release state. In particular, the coupling sections 15 are configured to provide the rotationally fixed coupling as a releasable rotationally fixed coupling.

Exemplarily, two coupling sections 15 are present. In an alternative embodiment, in particular an embodiment with only one brake body 3, there is preferably only one coupling section 15.

The coupling sections 15 are expediently arranged on the shaft 2, in particular fastened thereto. Exemplarily, the coupling sections 15 are each designed as a nut and are screwed onto the shaft 2. According to an alternative embodiment, the coupling sections 15 are part of the shaft 2.

Each coupling section 15 is in contact with a respective brake body 3A, 3B, in particular with its respective end face. Suitably, each coupling section 15 is pressed against a respective brake body 3A, 3B, in particular in the axial direction. The contact between a respective coupling section 15 and a respective brake body 3A, 3B provides a frictional connection, which in turn provides the rotationally fixed coupling between the respective brake body 3A, 3B and the shaft 2.

The actuating section 16 will be discussed in more detail below.

The actuating section 16 serves to actuate the brake bodies 3A, 3B to thereby provide the relative rotational movement between the brake bodies 3A, 3B and the shaft 2. In particular, the actuating section 16 serves to rotationally brake the brake bodies 3A, 3B by contact (while the shaft 2 expediently continues to rotate).

In an exemplary embodiment, the actuating section 16 has two actuating portions 32—a first actuating portion 32A for actuating the first brake body 3A and a second actuating portion 32B for actuating the second brake body 3B. In an exemplary embodiment, the actuating section 16 is U-shaped, the actuating portions 32 being formed by respective legs.

The actuating section 16 is expediently set into an actuating movement towards the brake bodies 3 by the actuator unit 6, in order to actuate the brake bodies 3. The actuating movement comprises in particular a linear movement of the actuating section 16, in particular in the radial direction of the shaft 2. The actuating movement is in particular a movement of the actuating section 16 relative to the brake bodies 3.

Expediently, the actuator unit 6 comprises an electric actuator for imparting the actuating movement to the actuating section 16. Expediently, the actuator unit 6 comprises a solenoid and/or a piezo unit for imparting the actuating movement to the actuating section 16. Alternatively or additionally, the actuator unit 6 comprises a pneumatic cylinder for imparting the actuating movement to the actuating section 16.

Furthermore, for setting the actuating section 16 in the actuating movement, the actuator unit 6 may comprise an actuator of a different design, in particular a piezoelectric actuator, an electromagnetic actuator, a shape memory alloy actuator (SMA actuator), an electroactive polymer actuator (EAP actuator), a magnetic shape memory actuator (MSM actuator), a pneumatic actuator, a hydraulic actuator, a pyroactuator, a mechanical actuator, an electrostrictive actuator and/or a thermal actuator.

Preferably, the tool device 10 is adapted to set the actuating section 16 in the actuating movement to bring the actuating section 16 into contact with the brake bodies 3 and thereby cause the braking device 12 to change from the release state to the feed state.

Expediently, the tool device 10 is adapted to set the actuating section 16 in the actuating movement on the basis of the detected operating state, in particular the emergency state.

Alternatively, or in addition to the described embodiment in which the braking device 12 is actively triggered by the actuator unit 6, the tool device 10 can also be designed in such a way that the braking device 12 is triggered in a different way—i.e. not by an actuator unit. For example, the braking device 12 may be torque actuated. This can be achieved, for example, by changing the rotational speed of the drive unit 5, in particular by means of a corresponding closed-loop control. Due to the coupling of the drive unit 5 to the shaft 2, the rotational speed of the shaft 2 is thereby also changed. Due to a jerky change in rotational speed, in particular an acceleration, of the shaft 2 and the mass inertia of the brake body 3, torque arises between the shaft 2 and the brake body 3 which leads to a release of the brake body 3 from the release state and, expediently, further to a relative speed change between the shaft 2 and the brake body 3.

Exemplarily, the tool device 10 further comprises a bearing section 25 on which the shaft 2 is mounted, in particular radially and/or axially. Exemplarily, the shaft 2 is supported by one of its ends on the bearing section 25. The bearing section 25 comprises a rotary bearing 26, exemplarily a roller bearing.

An exemplary operation of the tool device 10 will be described below.

Expediently, the tool 1 is driven by the drive unit 5. The workpiece 11 is processed by the driven tool 1. During processing, contact occurs between the tool 1 and the user's body. The control unit 7 detects this contact as an emergency state and thereupon triggers the braking device 12. The actuator unit 6 actuates the actuating section 16 to actuate the brake bodies 3, thereby putting the braking device 12 from the release state to the feed state. A relative rotational movement between the brake bodies 3 and the shaft 2 results, which is translated into axial movements 31A, 31B of the brake bodies 3 up to the brake section 14. Exemplarily, the brake bodies 3 move towards each other when performing the axial movements 31A, 32B. The braking device 12 is in the braking state when the brake bodies 3 contact the brake section 14. As a result of the contact between the brake bodies 3 and the brake section 14, the shaft 2 and the tool 1 are braked to a standstill. In particular, the braking occurs in less than 5 ms.

Expediently, the braking device 12 is returned to the release state, in particular automatically by the tool device 10 and/or by a manual actuation. The tool 1 is again driven by the drive unit 5. The workpiece 11 or another workpiece is then processed by the tool 1. Expediently, no replacement of the tool 1 and/or of the brake bodies 3 takes place between the braking of the tool 1 and/or of the shaft 2 and the renewed processing.

According to a preferred embodiment, the tool device 10 is configured to set the braking device 12 back into the release state, in particular by means of the actuator unit 6 and/or a further actuator unit. Preferably, the tool device 10 is configured to move the braking device 12 back to the release state in response to a reset command. The reset command is expediently entered into the tool device 10 by a user, for example via an input device, in particular a button.

FIGS. 6 and 7 show a reset mechanism 40, which is expediently part of the tool device 10. The reset mechanism 40 is used to return the braking device 12 to the release state. Exemplarily, the reset mechanism comprises a reset element 41, for example a lever, having a reset element contact portion 42 which can be brought into contact with a brake body contact portion of the brake body 3, for example the cylinder section 19, in particular by a linear movement, and may be positively connected to the brake body contact portion. A rotational movement (in particular manually effected) of the reset element 41 then causes the brake body 3 to rotate, thus bringing it back into the release state. In FIG. 6, the reset mechanism 40 is in an inactive state in which the reset contact portion 42 does not contact the brake body contact portion. In FIG. 7, the reset mechanism 40 is in an active state in which the reset contact portion 42 contacts the brake body contact portion.

Alternatively or in addition thereto, the tool device 10 is configured such that the braking device can be returned to the release state via manual actuation of the tool 1 and/or of the shaft 2 and/or of an operating element, for example a lever, that is mechanically coupled to the shaft 2. Alternatively or additionally, the tool device 10 is configured in such a way that the braking device can be returned to the release state via manual actuation of the brake body 3 and/or of an operating element, for example a lever, that is mechanically coupled to the brake body 3.

The tool device can also be expediently designed as an angle device, for example as an angle grinder, angle screwdriver or angle drill.

Expediently, the tool device comprises a first shaft, for example an input shaft, and a second shaft, for example an output shaft. Preferably, the first shaft and the second shaft are coupled to each other by means of a redirecting joint. Expediently, the first shaft or the second shaft is the aforementioned shaft braked by means of the braking device.

1. A tool device, comprising a shaft and a braking device with at least one brake body and a brake section, the tool device being adapted to:
in the course of a braking operation, put the braking device from a release state into a braking state via a feed state,
provide a rotationally fixed coupling between the at least one brake body and the shaft in the release state, so that the at least one brake body rotates with the shaft in the release state,
in the feed state, provide a relative rotational movement between the at least one brake body and the shaft and convert the relative rotational movement into an axial movement of the at least one brake body towards the brake section, and
in the braking state, exert a braking force on the shaft by a contact of the at least one brake body with the brake section so that the shaft is braked.

2. The tool device according to claim 1, further comprising a drivable tool coupled to the shaft such that the tool is braked together with the shaft in the braking state.

3. The tool device according to claim 1, wherein the shaft has a higher rotational speed than the brake body during the relative rotational movement.

4. The tool device according to claim 1, wherein the tool device is adapted to rotationally brake the at least one brake body relative to the shaft to provide the relative rotational movement between the at least one brake body and the shaft.

5. The tool device according to claim 1, wherein the tool device is adapted to effect the relative rotational movement by a jerk-like rotational speed change, of the shaft.

6. The tool device according to claim 1, further comprising a coupling mechanism for providing the rotationally fixed coupling in the release mode.

7. The tool device according to claim 6, wherein the coupling mechanism is adapted to provide the rotationally fixed coupling between the at least one brake body and the shaft in the release mode by frictional engagement.

8. The tool device according to claim 1, further comprising a conversion mechanism for converting the relative rotational movement into the axial movement.

9. The tool device according to claim 8, wherein the conversion mechanism comprises a thread and the tool device is adapted to convert the relative rotational movement into the axial movement in the feed state using the thread.

10. The tool device according to claim 9, wherein the thread is arranged on the shaft.

11. The tool device according to claim 1, wherein the at least one brake body comprises a first brake body and a second brake body, and wherein the tool device is adapted to provide, in the feed state, a relative rotational movement between the two brake bodies and the shaft and to convert the relative rotational movement into mutually opposite axial movements of the brake bodies towards the brake section.

12. The tool device according to claim 11, further comprising a first thread and a second thread, wherein the tool device is adapted to convert the relative rotational movement into a first axial movement of the first brake body in the feed state using the first thread and to convert the relative rotational movement into a second axial movement of the second brake body using the second thread, the second axial movement being opposite to the first axial movement.

13. The tool device according to claim 12, wherein the first thread differs in its thread direction from the second thread.

14. The tool device according to claim 1, wherein the brake section has a pivot bearing bearing the shaft.

15. The tool device according to claim 1, wherein the tool device comprises an actuating section and is adapted to contact with the actuating section the at least one brake body to thereby provide the relative rotational movement between the at least one brake body and the shaft.

16. The tool device according to claim 1, wherein the tool device is adapted to detect an operating state and to trigger the braking operation based on the detected operating state.

17. The tool device according to claim 16, wherein the tool device is configured to detect as the operating state an emergency state.

18. The tool device according to claim 1, wherein the tool device is adapted to move the braking device from the braking state back to the release state.

19. A method of braking a shaft of a tool device, comprising the step of:
putting a braking device, which has at least one brake body, and a brake section, from a release state, in which the at least one brake body is coupled in a rotationally fixed manner to the shaft, so that the at least one brake body rotates with the shaft, via a feed state in which a relative rotational movement between the at least one brake body and the shaft is converted into an axial movement of the at least one brake body towards the brake section, into a braking state in which the at least one brake body is in contact with the brake section and exerts a braking force on the shaft so that the shaft is braked.

20. (canceled)

21. The tool device according to claim 1, wherein the brake body is a brake disc.

22. The tool device according to claim 5, wherein the jerk-like rotational speed change is a rotational acceleration.

23. The tool device according to claim 17, wherein the emergency state is a contact between the tool and a human body and/or is a kickback.
